(19) United States
(12) Patent Application Publication
(10) Pub. No.: US 2015/0210390 A1
(43) Pub. Date: Jul. 30, 2015

(54) TOW PLATE AND LOAD EXTRACTION SYSTEM

(71) Applicant: AIRBUS OPERATIONS GMBH, Hamburg (DE)

(72) Inventors: Roland Gad, Hamburg (DE); Jörg Wyrembek, Hamburg (DE); Svenja Jegminat, Hamburg (DE)

(21) Appl. No.: 14/606,747

(22) Filed: Jan. 27, 2015

(30) Foreign Application Priority Data
Jan. 27, 2014 (EP) 14152744.0

(51) Int. Cl. B64D 1/12

(52) U.S. Cl. CPC B64D 1/12

(57) ABSTRACT

A tow plate for retaining and releasing an extractable unit from an aerospace vehicle including a base plate, an actuating assembly and a retaining assembly. The actuating assembly and the retaining assembly releasably hold a load transmission unit attached to the tow plate. The actuating assembly includes a movable locking element. The load transmission unit can be detached from the tow plate when the locking element has been moved to a releasing position. The retaining assembly includes at least one load sensor for measuring load acting on the load transmission unit. The tow plate includes a central data processing unit to move the at least one locking element from the retaining position to the releasing position when the load acting on the load transmission unit measured by the load sensor exceeds a predetermined value. Further, a load extraction system and a method for releasing a load transmission unit are described.

### CROSS-REFERENCE TO RELATED APPLICATION

This application claims priority to European Patent Application No. 14152744.0 filed Jan. 27, 2014, the entire disclosure of which is incorporated by reference herein.

### TECHNICAL FIELD

The present disclosure relates to a tow plate comprising a base plate, an actuating assembly and a retaining assembly.

### BACKGROUND

The actuating assembly and the retaining assembly are rigidly attached to the base plate. The actuating assembly comprises at least one locking element and at least one actuator for moving the at least one locking element between a retaining position and a releasing position. The actuating assembly and the retaining assembly are arranged for releasably holding a load transmission unit attached to the tow plate when the at least one locking element is in the retaining position. A load transmission unit held by the actuating assembly and the retaining assembly can be detached from the tow plate when the at least one locking element has been moved to the releasing position by the at least one actuator. The subject matter disclosed herein further relates to a load extraction system and a method for releasing a load transmission unit.

Aerial delivery of cargo units, i.e. dropping of cargo from a flying aircraft, by parachutes is one way of providing supply in areas that are cut-off from ground supply and lack landing areas for aircraft. Contrary to what is implied by the term “drop”, cargo units have to be pulled out of the aircraft, i.e. extracted from the aircraft, with the correct extraction velocity to ensure that the cargo units will leave the cargo bay of the aircraft in a defined manner. To generate a sufficiently high extraction velocity, cargo units are pulled out of the cargo bay of the aircraft by an extraction parachute.

The extraction parachute is connected to the cargo unit via a so-called tow plate as known, inter alia, from U.S. Pat. No. 3,801,051. The particular tow plate disclosed therein is primarily used for connecting a so-called drogue parachute to an extraction parachute. The drogue parachute is a smaller parachute that is commonly used to extract the extraction parachute from the cargo bay of the aircraft. However, it may also be used to extract lightweight cargo units from the cargo bay.

The tow plate comprises a base plate, a retaining assembly and a mechanical actuating assembly. Both the retaining assembly and the actuating assembly are rigidly attached to the base plate. The actuating assembly and the retaining assembly releasably hold a load transmission unit in form of a clevis assembly. Both the drogue parachute and the extraction parachute that is to be extracted are connected to the clevis assembly by lines. When the extraction parachute shall be pulled from the aircraft, first the drogue parachute is to be released via a tow plate that is only designed for drogue parachutes. An operator than has to wait until the drogue parachute has been sufficiently filled with air, creates a sufficiently high extraction force and the drop zone where the extractable unit shall be delivered has been reached. If the operator is of the opinion that all release conditions for the extractable unit are fulfilled, he manually actuates the actuation assembly and releases the load transmission unit from the tow plate where the drogue parachute is attached. Now the extraction parachute will be pulled out of the aircraft by the drogue parachute. A similar tow plate system can be used to connect the extraction parachute to extractable units in form of cargo units and to ensure that the extraction parachute generates a sufficiently high extraction force to securely extract the cargo units.

Former tow plate designs applied for the usage of drogue parachutes only, are, however, disadvantageous as they rely completely on the experience of the operator of the tow plate to operate. Thus, there appears to be a need for an improved tow plate to ensure that the actuating assembly is only actuated and the load transmission unit is only released when a sufficiently high extraction force is generated.

### SUMMARY

In a first aspect an object underlying the present disclosure is solved by a tow plate comprising at least one load sensor adapted for measuring a load acting on a load transmission unit by an extraction unit while the load transmission unit is releasably held by the actuating assembly and the retaining assembly. The tow plate further comprises a central data processing unit connected to the at least one load sensor and the at least one actuator, wherein the central data processing unit is adapted to instruct the at least one actuator to move the at least one locking element from the retaining position to the releasing position when the load measured by the load sensor exceeds a predetermined value.

The tow plate according to the present disclosure comprises a base plate, an actuating assembly and a retaining assembly. The base plate can be rigidly coupled to an aircraft, e.g. the floor of the cargo bay of a cargo or transport aircraft. Both the actuating assembly and the retaining assembly are rigidly attached or mounted to the base plate and can, thus, be rigidly coupled through the base plate to an aircraft structure.

The actuating assembly and the retaining assembly cooperate to form a releasable holding assembly for a load transmission unit. To this end the actuating assembly comprises a locking element that can be moved between a locking position and a releasing position. If the locking element is in the locking position, a load transmission unit held by the retaining assembly and the actuating assembly is rigidly attached to the base plate and, thus, rigidly coupled to an aircraft through the tow plate. The actuating assembly and the retaining assembly are designed, i.e. are sufficiently rigid, to capture any loads regularly acting on the load transmission unit and retain the load transmission unit in place. Hence, any loads acting on the load transmission unit by an extraction element are not transferred to an extractable unit attached to the load transmission unit but are completely absorbed by the tow plate. For example, the actuating assembly and the retaining assembly are dimensioned to retain the load transmission unit even if an extraction unit in form of a fully inflated drogue or extraction parachute pulled by an aircraft at a cargo drop-off velocity is directly attached to the load transmission unit.

For removing or releasing a load transmission unit from the tow plate, the locking element can be moved to a releasing or non-locking position. To this end the locking assembly comprises at least one actuator adapted to move the locking element between the locking position and the releasing position. In a preferred exemplary embodiment the actuator is an electrical actuator. However, the actuator may be of any other form of actuator such as a hydraulic actuator as long as its operation can be controlled by a central data processing unit. Once the locking element has been moved to the releasing position, a load transmission unit previously held by the retaining assembly can be moved away from the tow plate. If, for example, a fully inflated drogue parachute as extraction unit is attached to the load transmission unit and the locking element is moved to the releasing position, the drogue parachute pulls the load transmission unit away from the tow plate and any extractable unit, e.g. an extraction parachute or a cargo unit, out of the cargo bay of the aircraft.

The retaining assembly further comprises at least one load sensor adapted for measuring a load acting or impeding on a load transmission unit by an extraction unit. In other words, the load sensor is adapted to measure the load that an extraction unit such as a drogue parachute or an extraction parachute connected to the load transmission unit creates when released in the airstream around the aircraft. This load can also be referred to as an extraction force.

The load measured by the load sensor is transferred to a central data processing unit connected both to the load sensor and the actuator. To this end the central data processing unit is equipped with the necessary connectors. Further, the central data processing unit is adapted to compare the load measured or determined by the load sensor with a pre-set or predefined or predetermined load value. Adapting a data processing unit may be conducted by installing software on the data processing unit or by providing hardware enabling the data processing unit to perform all stipulated actions. If the measured load reaches or exceeds the predefined load value, the central data processing unit is adapted to instruct the actuating assembly, and to be more precise the actuator, to move the locking element from the locking position to the releasing position so that a load transmission unit can be detached from the tow plate.

The central data processing unit may be an integrated circuit locally installed in the tow plate itself, e.g. in the housing of the actuating assembly. However, in an exemplary preferred embodiment the central data processing unit is part of the aircraft's load management system. Thus, apart from comparing the measured load to a predetermined load the central data processing unit may also provide a recording function storing any measured values. Additionally, the central data processing unit may also be adapted to include further restrictions in the process of instructing the actuating assembly to release the load transmission unit. For example, the central data processing unit may be connected to the aircraft's navigation system and be adapted to only release the load transmission unit if the load exceeds a predetermined value and a predetermined geographic position, i.e. the drop zone, has been reached.

Hence, the present disclosure advantageously allows determining precisely when a sufficiently high extraction force is generated, i.e. when a sufficiently high load is measured by the load sensor, to safely drop an extractable unit from an aircraft. The necessary extraction force can be determined, for example, as a function of the weight of the extractable unit and the employed drop-off mode. Thus, the determination if a sufficiently high extraction force is generated does not further rely on operator experience which reduces the risk of damage of the released cargo and/or aircraft.

In a preferred embodiment the retaining assembly comprises two load sensors adapted for measuring a load acting on a load transmission unit by an extraction unit through an extraction line connected to the load transmission unit while the load transmission unit is releasably held by the actuating assembly and the retaining assembly. The central data processing unit is connected to both load sensors. The central data processing unit is adapted to instruct the at least one actuator to move the at least one locking element from the retaining position to the releasing position only when the load acting on the load transmission unit by the extraction unit measured by each of the two load sensors exceeds a predetermined value.

Thus, in the preferred embodiment the locking element of the tow plate is only moved to the releasing position if both load sensors measure a sufficiently high extraction force. Hence, a robust measurement of the load is provided that prevents accidental release of the tow plate if the load generated by the extraction device is not sufficiently high.

In a further preferred embodiment the actuating assembly comprises two actuators for moving the at least one locking element between the retaining position and the releasing position, wherein both actuators are connected to the central data processing unit and the central data processing unit is adapted to instruct both actuators to move the locking element from the retaining to the locking position. Thus, in the preferred embodiment a redundant and less error-prone actuating assembly is provided. Even if one of the actuators fails, a second actuator is provided for releasing the load transmission unit upon instruction by the central data processing unit.

In a preferred embodiment each load sensor is connected to the central data processing unit via a separate local data processing unit. Each local data processing unit is adapted to determine a load acting on a load transmission unit by an extraction unit from a signal of the respective load sensor connected to the local data processing unit and to transmit the determined load to the central data processing unit. Providing local data processing units—one for each load sensor—further increases the mission reliability of the tow plate operation compared to a tow plate relying only on a single central data processing unit. The load measured by each sensor is determined by an independent local data processing unit separate from the local data processing units that determine the load of other load sensors. Thus, even if one of the local data processing units should malfunction and erroneously determine a higher load that already exceeds the predetermined load though the actually generated load has not reached the predetermined value, the second local data processing unit still determines the correct lower load from the other load sensor and the load transmission unit will not be released too early. The local data processing units may also be integrated circuits that are integrated into the tow plate itself but can also be other kinds of data processing units arranged spaced apart from the tow plate.

In a second aspect the problem is solved by a load extraction system for retaining an extractable unit in a cargo bay of an aerospace vehicle and releasing the extractable unit from the cargo bay. The system comprises a tow plate according to any of the preceding embodiments and an extractable unit retaining assembly. The extractable unit retaining assembly comprises a holder for releasably retaining an extractable unit. The holder can be moved between a holding position in which an extractable unit can be held by the holder attached to the extractable unit retaining assembly and a releasing position in which an extractable unit can be detached from the extractable unit retaining assembly. The central data processing unit is adapted to instruct the extractable unit retaining assembly to move the holder from the holding position to the releasing position after moving the at least one locking element from the retaining position to the releasing position.

The load extraction system according to the present disclosure comprises apart from an embodiment of a tow plate according to the present disclosure also an extractable unit retaining assembly. The extractable unit retaining assembly is used to hold an extractable unit, such as a unit load device, in place during flight until it is dropped. To this end the extractable unit retaining assembly comprises a plurality of holders that can be moved between a releasing and a retaining position. In the retaining position an extractable unit held by the extractable unit retaining system cannot move away from position. Thus, the retaining system prevents any unintended movement of the extractable unit during flight, e.g. due to flight manoeuvres, that could put the aircraft personal or even the aircraft itself in danger. If the holders are, however, moved to the releasing position, the extractable units can be moved and, in particular, pulled out of the aircraft by an extraction parachute. To ensure that the holder is moved to the releasing position in due time once a load transfer unit connected to an extractable unit held by the extractable unit retaining assembly has been released, the latter is also connected to the central data processing unit.

The central data processing unit is adapted to instruct the extractable unit retaining assembly to move the holder from the retaining to the releasing position after having instructed the actuators of the retaining assembly to move the at least one locking element from the retaining to the releasing position. In an exemplary preferred embodiment the central data processing unit is adapted to continuously monitor the loads measured by the load sensors after the at least one locking element has been moved to the releasing position. As soon as the measured load drops to zero, the central data processing unit instructs the extractable unit retaining assembly to release the extractable unit.

Thus, the load extraction system according to the present disclosure provides additional safety by releasing extractable units not before the load transmission unit has been released and the extraction parachute may readily begin to pull the extractable unit out of the cargo bay of the aircraft. Thereby, any risk of unintended and undirected movement of the extractable units is further reduced.

In a preferred embodiment the load extraction system further comprises a load transmission unit, an extractable unit and an extraction unit. The extractable unit is adapted to be held by the extractable unit retaining assembly and connected to the load transmission unit by a device line and the extraction unit is connected to the load transmission unit by an extraction line. The load transmission unit is adapted to be releasably held by the actuating assembly and the retaining assembly of the tow plate. Preferably the extraction unit is a drogue parachute, an extraction parachute or a cargo unit. Further, it is preferred that the extractable unit is an extraction parachute or a cargo unit.

The preferred embodiments of the load extraction system share the advantages of the embodiments of the tow plate according to the present disclosure employed therein.

In a further aspect the object is solved by a method for releasing a load transmission unit held between at least one locking element of an actuating assembly in a retaining position and a retaining assembly. The actuating assembly and the retaining assembly are part of a tow plate. The method comprises measuring a load acting on the load transmission unit by an extraction unit, comparing the measured load with a predetermined value and moving the at least one locking element from the retaining position to a releasing position when the predetermined value is exceeded, wherein the load transmission unit can be detached from the tow plate when the locking element is in the releasing position.

In a preferred embodiment measuring the load acting on the load transmission unit comprises performing two independent measurements of the load acting on the load transmission unit with separate load sensors. Further, comparing the measured load with a predetermined value comprises comparing the measured loads of both independent measurements to the predetermined value, wherein the at least one locking element is only moved to the releasing position when both measured loads exceed the predetermined value.

It is further preferred that the method comprises moving a holder of an extractable unit retaining assembly to a releasing position after moving the at least one locking element to the releasing position, such that an extractable unit held by the holder in a holding position can be detached from the extractable unit retaining assembly.

The preferred embodiments of a method for releasing a load transmission unit share the advantages of those embodiments of the tow plate and the load extraction system according to the present disclosure comprising structural features that correspond to the respective functional features of the preferred embodiments of the method for releasing a load transmission unit.

### BRIEF DESCRIPTION OF THE DRAWINGS

The present disclosure will now be described in more detail with reference to the drawings depicting merely exemplary embodiments, wherein

FIG. 1 is a top view of a schematic representation of an exemplary embodiment of a tow plate according to the present disclosure,

FIG. 2 is a sectional side view of the schematic representation of the exemplary embodiment of a tow plate of FIG. 1,

FIG. 3 is a schematic representation of an exemplary embodiment of a load extraction system according to the present disclosure in which a load transmission unit is held by the tow plate and

FIG. 4 shows the exemplary embodiment of FIG. 3 with the load transmission unit having been released from the tow plate.

### DETAILED DESCRIPTION

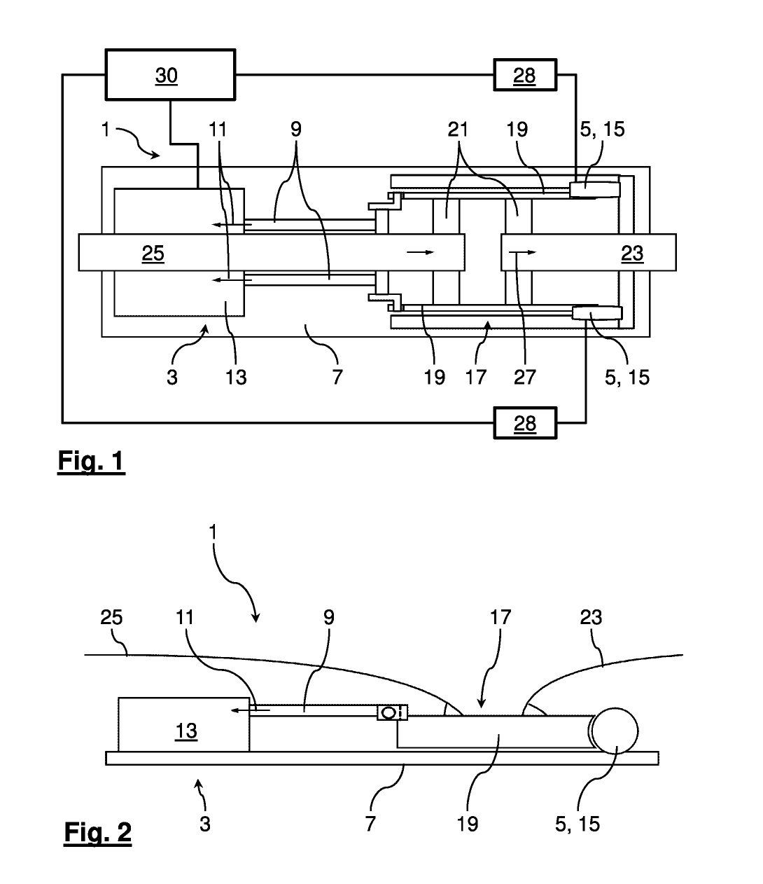

With reference to FIGS. 1 and 2 of the drawings an exemplary embodiment of a tow plate 1 according to the present disclosure will now be described. The tow plate 1 comprises an actuating assembly 3 and a retaining assembly 5 which are rigidly attached or mounted to a base plate 7 that forms part of the tow plate 1. The base plate 7 is adapted to be mounted to a floor of a cargo bay of a transport or cargo aircraft.

The actuating assembly 3 comprises two actuators which drive the same locking element 9 that can be moved between a locking or retaining position and a non-locking or releasing position in a direction indicated by arrows 11. The actuators are arranged in a housing 13 of the actuating assembly 3. The actuators are preferably electrical or hydraulic actuators. Advantageously each actuator can move the locking element 9 independently of the other actuator such that a redundant and, thus, less error prone operation of the locking element 9 can be achieved.

The retaining assembly 5 is formed by two cam followers 15 rotatably connected to the base plate 7. Between the retaining assembly 5, i.e. the cam followers 15, and the locking element 9 of the actuating assembly 3 a load transmission unit 17 in form of a clevis assembly 17 is releasably held or retained. The clevis assembly 17 comprises two parallel side bars 19 that are interconnected by two attachment bars 21 that extend in a direction perpendicular to the extension direction of the side bars 19. The clevis assembly 17 is in other words H-shaped with double cross bars. The attachment bars 21 can be used to connect the load transmission unit 17 to an extraction unit via an extraction line 23 and to an extractable unit via a device line 25. The side bars 19 can be used to transfer loads between the two attachment bars 21 and to retain the load transmission unit 17 or clevis assembly 17 attached to the tow plate 1.

In each of the cam followers 15 a load sensor has been installed that is arranged for measuring the load acting on the load transmission unit 17. These load sensors are adapted to measure or determine the load or force that is created by the extraction line 23 i.e. the force that pulls the load transmission unit 17 in the direction of the arrow 27. Each load sensor is connected to a separate local data processing unit 28. The local data processing units 28 may be part of the tow plate 1. However, they can also be arranged spaced apart from the tow plate 1. In the embodiments shown in the figures the local data processing units 28 are formed as integrated circuits. Each local data processing unit 28 receives a signal from one load sensor corresponding to the measured load. From the received signal the local data processing unit 28 determines the load acting onto the load transmission unit 17. In other words, each local data processing unit 28 is adapted to convert the measured raw data into an engineering value. The determined value is than transmitted to a central data processing unit 30. By providing a separate local data processing unit 28 for each load sensor, mission reliability of the tow plate 1 operation is further increased. Even if one of the local data processing units 28 should fail and accidentally determine too high loads generated by the extraction unit, the second local data processing unit 28 still independently determines the correct load and the load transmission unit 17 will not be released too early.

The central data processing unit 30 may be installed inside the tow plate 1. However, in the present embodiment shown in FIGS. 1 and 2 the central data processing unit 30 is part of the aircraft's cargo management system and provides additional functionality related to the retaining and releasing of extractable units from the aircraft's cargo bay. The central data processing unit 30 compares the measured value to a pre-set or predetermined value. The predetermined value can be varied to match the weight or the dimensions of the extractable unit that shall be released from the aircraft. If the predetermined value is reached or exceeded, the system or central data processing unit 30 instructs the actuators to which it is also connected to move the locking element 9 into the direction of the arrows 11 in the releasing position. The side bars 19 are now no longer held in position by the locking element 9 and may rotate about the cam followers 15. Thus, the load transmission unit 17 as a whole may move away from the tow plate 1 in the direction into which it is pulled by the extraction line 23. Thereby, the device line 25 is tightened and the load acting on the load transmission unit 17 that was previously transferred to the tow plate 1 is now fully acting through the load transmission unit 17 onto the device line 25 and via the device line 25 onto an extractable unit connected to the device line 25.

Hence, the tow plate 1 according to the present disclosure advantageously ensures that the load transmission unit 17 is only released when a sufficiently high extraction force acts on the load transmission unit 17 to ensure safe extraction of the extractable units. Contrary to prior art tow plates the determination if sufficient load is generated does not rely on operator experience only, whereby safety of the aircraft personal operating the tow plate and the extractable units itself are increased.

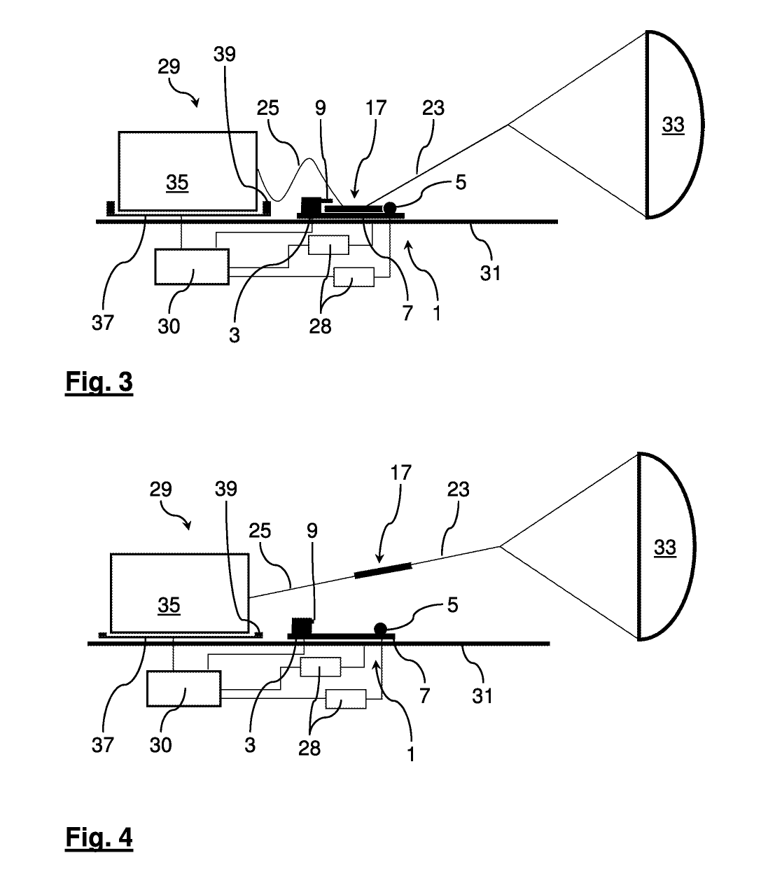

In FIGS. 3 and 4 an exemplary embodiment of a load extraction system 29 according to the present disclosure is depicted. The load extraction system 29 comprises an embodiment of a tow plate 1 according to the present disclosure corresponding to the tow plate 1 of FIGS. 1 and 2. Like numerals in the Figures indicate like elements. In the following only those features of the load extraction system 29 will be described here in further details that have not yet been described with reference to FIG. 1 or 2.

The base plate 7 of the tow plate 1 that forms part of the load extraction system 29 is rigidly attached to a floor 31 of the cargo bay of a transport aircraft. The tow plate 1 releasably holds or retains a load transmission unit 17 between the locking element 9 in the locking position and the retaining assembly 5. The load transmission unit is connected through the extraction line 23 to an extraction unit 33 in form of an extraction parachute 33 that has been released into the airstream around the aircraft. As long as the load transmission unit 17 is held by the tow plate 1, any force generated by the extraction parachute 33 acting through the extraction line 23 onto the load transmission unit 17 is transferred into the floor, i.e. the structure, of the transport aircraft. No force or load whatsoever is, however, transferred trough the device line 25 that is also connected to the load transmission unit 17 to the extractable unit 35 in form of a unit load device 35.

While the load transmission unit 17 is held by the tow plate 1, the load sensors that are part of the retaining assembly 5 constantly measure the load acting on the load transmission unit 17 and transfer the measured values through the local data processing units 28 to the central data processing unit 30. When the extraction parachute 33 is released into the airstream and begins to fill with air, the previously loose extraction line 23 begins to tighten. The load acting on the load transmission unit 17 that is measured by the load sensors begins to increase. A signal corresponding to the measured load is transferred to the local data processing units 28, which determine a numeric value for the measured loads and provide this value for further processing to the system or central data processing unit 30. Here, the measured values are compared to a predetermined value that depends, for example, on the type of the extractable unit 35, the weight of the extractable unit 35 and the extraction mode. Once the predetermined load value has been reached or exceeded, the central data processing unit 30 instructs the actuators of the actuating assembly 3 to move the locking element 9 to the releasing position. In FIG. 4 the locking element 9 is shown in a releasing or non-locking position.

As can be seen in FIG. 4, the load transmission unit 17 is then pulled of the tow plate 1 by the extraction parachute 33. The load or extraction force generated by the latter is now not transferred to the tow plate 1 anymore but pulls the device line 25 and begins to extract the unit load device 35 from the cargo bay of the cargo aircraft.

The load extraction system 29 according to the present disclosure further comprises an extractable unit retaining assembly 37. The extractable unit retaining assembly 37 is adapted to securely hold an extractable unit 35 or cargo unit 35 in place during the flight. In particular, the extractable unit retaining assembly 37 prevents any unintended movement of the cargo unit 35 that might put the aircraft personal or the aircraft itself at risk. To allow dropping the cargo off the aircraft the extractable unit retaining assembly 37 comprises a holder 39 that releasably hold the cargo units 35. The holder 39 can be moved between a holding position depicted in FIG. 3 and a releasing position depicted in FIG. 4. In the holding position the extractable unit 35 is safely held in place. However, if the holder 39 is moved to the releasing position, the extractable unit 35 can be pulled out of the aircraft by the extraction parachute 33.

For controlling the movement of the holder 39 the extractable unit retaining assembly 37 is also connected to the central data processing unit 30. The central data processing unit 30 is adapted to instruct the extractable unit retaining assembly 37 to move the holder 39 to the releasing position and, thus, release the extractable unit 35, after the load transmission unit 17 has been released. In particular, the central data processing unit 30 is adapted to continuously monitor the loads provided by the local data processing units 28 after the load transmission unit 17 has been released. Once the load transmission unit 17 has fully detached from the tow plate 1 and the measured loads drop to zero, the central data processing unit 30 instructs the extractable unit retaining assembly 37 to move the holder 39 to the releasing position. By providing an extractable unit retaining system 37 and adapting the central data processing unit 30 in the described manner, the extractable unit 35 is only just released before the extraction parachute 33 begins to pull the extractable unit 35 out of the aircraft. Thus, any unintentional movement of the extractable unit 35 that might harm aircraft personal and damage other cargo or the aircraft itself is advantageously prevented.

The exemplary embodiment of a load extraction system 29 according to the present disclosure shares the advantages of the exemplary embodiment of a tow plate 1 according to the present disclosure depicted in FIGS. 1 and 2. In particular, the correct time to release the load transmission unit 17 is determined by the load generated by the extraction unit 33 and does not depend on operator experience. Further, providing two load sensors 9 prevents accidental release of the load transmission unit 17 and, thus, the extractable unit 35 in case one of the load sensors malfunctions.

The exemplary embodiments of the tow plate 1 and the load extraction system 29 according to the present disclosure also resemble an exemplary embodiment of a method for releasing a load transmission unit 17 according to the present disclosure. In a first step of the exemplary embodiment of the method each of the load sensors inside the cam followers 15 independently of the other load sensor measures a load acting on a clevis assembly or load transmission unit 17 releasably held by the tow plate 1. The measured values are pre-processed by the local data processing units 28 and further transmitted to the central data processing unit 30 where they are compared to a predetermined value. If the load measured in both independent measurements exceeds the predetermined value, the central data processing unit 30 instructs the actuating assembly 3 to move the locking element 9 from the retaining to the releasing position such that the load transmission unit 17 can be detached from the tow plate 1.

Furthermore, the central data processing unit 30 instructs the extractable unit retaining assembly 37 to move the holder 39 to the releasing position after moving the locking element 9 to the releasing position, such that the extractable unit 35 can be detached from the retaining assembly 37 and extracted out of the cargo bay of the aircraft. The exemplary embodiment of the method for releasing a load transmission unit 17 shares the advantages of the respective embodiments of the tow plate 1 and the load extraction system 29 according to the present disclosure.

1. A tow plate comprising a base plate, an actuating assembly and a retaining assembly:
wherein the actuating assembly and the retaining assembly are rigidly attached to the base plate;
wherein the actuating assembly comprises at least one locking element and at least one actuator for moving the at least one locking element between a retaining position and a releasing position;
wherein the actuating assembly and the retaining assembly are arranged for releasably holding a load transmission unit attached to the tow plate, when the at least one locking element is in the retaining position;
wherein a load transmission unit held by the actuating assembly and the retaining assembly can be detached from the tow plate, when the at least one locking element has been moved to the releasing position by the at least one actuator;
the retaining assembly comprising at least one load sensor adapted for measuring a load acting on a load transmission unit by an extraction unit while the load transmission unit is releasably held by the actuating assembly and the retaining assembly; and
the tow plate comprising a central data processing unit connected to the at least one load sensor and the at least one actuator, wherein the central data processing unit is adapted to instruct the at least one actuator to move the at least one locking element from the retaining position to the releasing position when the load measured by the at least one load sensor exceeds a predetermined value.

2. The tow plate according to claim 1, wherein the retaining assembly comprises two load sensors adapted for measuring a load acting on a load transmission unit by an extraction unit through an extraction line connected to the load transmission unit while the load transmission unit is releasably held by the actuating assembly and the retaining assembly; and
wherein the central data processing unit is connected to both load sensors wherein the central data processing unit is adapted to instruct the at least one actuator to move the at least one locking element from the retaining position to the releasing position only when the load measured by each of the two load sensors exceeds a predetermined value.

3. The tow plate according to claim 1, wherein the actuating assembly comprises two actuators for moving the at least one locking element between the retaining position and the releasing position, wherein both actuators are connected to the central data processing unit and the central data processing unit is adapted to instruct both actuators to move the locking element from the retaining to the locking position.

4. The tow plate according to claim 1, wherein each load sensor is connected to the central data processing unit via a separate local data processing unit;
wherein each local data processing unit is adapted to determine a load acting on a load transmission unit by an extraction unit from a signal of the respective load sensor connected to the local data processing unit and to transmit the determined load to the central data processing unit.

5. A load extraction system for retaining an extractable unit in a cargo bay of an aerospace vehicle and releasing the extractable unit from the cargo bay comprising a tow plate according to claim 1 and an extractable unit retaining assembly;
wherein the extractable unit retaining assembly comprises a holder for releasably retaining an extractable unit, wherein the holder can be moved between a holding position in which an extractable unit can be held by the holder attached to the extractable unit retaining assembly and a releasing position in which an extractable unit can be detached from the extractable unit retaining assembly, and
wherein the central data processing unit is adapted to instruct the extractable unit retaining assembly to move the holder from the holding position to the releasing position after moving the at least one locking element from the retaining position to the releasing position.

6. The load extraction system according to claim 5, wherein the load extraction system further comprises a load transmission unit, an extractable unit and an extraction unit;
wherein the extractable unit is adapted to be held by the extractable unit retaining assembly and connected to the load transmission unit by a device line and the extraction unit is connected to the load transmission unit by an extraction line; and
wherein the load transmission unit is adapted to be releasably held by the actuating assembly and the retaining assembly of the tow plate.

7. The load extraction system according to claim 5, wherein the extraction unit is a drogue parachute, an extraction parachute or a cargo unit.

8. The load extraction system according to claim 5, wherein the extractable unit is an extraction parachute or a cargo unit.

9. A method for releasing a load transmission unit held between at least one locking element of an actuating assembly in a retaining position and a retaining assembly, the actuating assembly and the retaining assembly forming part of a tow plate, the method comprising:
measuring a load acting on the load transmission unit by an extraction unit;
comparing the measured load with a predetermined value; and
moving the at least one locking element from the retaining position to a releasing position when the predetermined value is exceeded, wherein the load transmission unit can be detached from the tow plate when the locking element is in the releasing position.

10. The method according to claim 9, wherein measuring the load acting on the load transmission unit comprises performing two independent measurements of the load acting on the load transmission unit with two separate load sensors;
wherein comparing the measured load with a predetermined value comprises comparing the measured loads of both independent measurements to the predetermined value; and
wherein the at least one locking element is only moved to the releasing position when both measured loads exceed the predetermined value.

11. The method according to claim 9, further comprising moving a holder of an extractable unit retaining assembly to a releasing position after moving the at least one locking element to a releasing position, such that an extractable unit held by the holder in a holding position can be detached from the extractable unit retaining assembly.
